(19) United States
(12) Patent Application Publication
(10) Pub. No.: US 2025/0203255 A1
(43) Pub. Date: Jun. 19, 2025

(54) AUDIO DEVICE WITH HIDDEN CONNECTION POINT

(71) Applicant: Bose Corporation, Framingham, MA (US)

(72) Inventors: David Louis Pepin, Sutton, MA (US); Christopher Ratcliffe, Williamsburg, VA (US); Michael Edward Banaczuk, Blackstone, MA (US)

(21) Appl. No.: 18/541,359

(22) Filed: Dec. 15, 2023

(51) Int. Cl. H04R 1/02

(52) U.S. Cl. CPC H04R 1/02; H04R 2400/11

(57) ABSTRACT

Various implementations include audio devices. Certain implementations include an audio device including: an outer enclosure, an acoustic cavity within the outer enclosure, and at least one hidden connection point in the outer enclosure, the at least one hidden connection point configured to receive a corresponding fastener by penetrating the outer enclosure.

### TECHNICAL FIELD

This disclosure generally relates to audio devices. More particularly, the disclosure relates to an audio device with at least one hidden connection point.

### BACKGROUND

It may be desirable to mount or otherwise display an audio device, such as in a showroom or retail establishment, or for fixed usage in a hospitality setting such as a hotel room. Conventionally, specific subsets, or types of audio devices are manufactured for use in display settings. These audio devices can differ from the consumer/end user (or, deliverable) audio devices in terms of overall functionality, acoustic functionality, ingress protection, etc. In many conventional cases, these audio devices are “display-only” models, requiring the manufacturer to produce two distinct types of device, one for display purposes and another for consumer/end user purposes. In additional conventional cases, displaying an audio device, for example, mounting that device to a bracket or other fastener, renders the device inoperable in at least one aspect, e.g., acoustically, or in terms of ingress protection. As a result, mounting and/or display of conventional audio devices can result in increased manufacturing costs, inventory management costs, and/or wasted resources in producing devices with limited functionality.

### SUMMARY

All examples and features mentioned below can be combined in any technically possible way.

Various implementations include audio devices with at least one hidden connection point. Certain implementations include approaches for mounting an audio device with a hidden connection point.

In particular aspects, audio device includes: an outer enclosure, an acoustic cavity within the outer enclosure, and at least one hidden connection point in the outer enclosure, the at least one hidden connection point configured to receive a corresponding fastener by penetrating the outer enclosure.

In additional particular aspects, a method of mounting the audio device to a mounting bracket includes: positioning the mounting bracket on the audio device, the mounting bracket having a set of mounting apertures, positioning the corresponding fastener in each of the set of mounting apertures, puncturing the outer enclosure with the corresponding fastener, and seating the corresponding fastener in each of the at least one hidden connection points.

Implementations may include one of the following features, or any combination thereof.

In some cases, the outer enclosure includes a cover visible from an exterior of the audio device, and the at least one hidden connection point is not visible from the exterior of the audio device.

In particular aspects, the at least one hidden connection point includes a slot for receiving the fastener and is entirely enclosed by the outer enclosure.

In certain implementations, the at least one hidden connection point enables connection with an external device using the fastener.

In some cases, the external device includes a mounting bracket.

In particular cases, the outer enclosure is sized to complement the mounting bracket.

In certain aspects, the mounting bracket includes a set of arms, where the set of arms extend only partially along sidewalls of the audio device when mounted.

In particular examples, the mounting bracket further includes a set of extensions or additional arms for wrapping around an accessory mount on the audio device. In certain cases, the accessory mount includes a mount for an accessory such as a handle.

In further examples, the set of arms extend only partially along the sidewalls of the audio device, and in further examples, the fasteners provide a significant portion of the retention device for the audio device.

In some cases, the at least one hidden connection point is configured to be located with a corresponding mounting aperture in the mounting bracket.

In particular implementations, the mounting bracket aids in at least one of, display of the audio device, fixed use of the audio device, or theft deterrence for the audio device.

In certain implementations, the fastener includes a screw.

In some aspects, the screw includes at least one of a locking screw or a self-tapping screw.

In particular cases, the outer enclosure appears substantially identical to an outer enclosure of a reference audio device that is of a same type as the audio device and does not include hidden connection points.

In certain aspects, the audio device further includes a wall within the outer enclosure, the wall separating the at least one hidden connection point from the acoustic cavity.

In particular implementations, the wall includes a passive radiator.

In some implementations, the audio device is ported and does not include a passive radiator.

In certain cases, the fastener does not impact an acoustic performance of the audio device.

In some aspects, the fastener does not impact an ingress protection (IP) rating of the audio device.

In particular implementations, the audio device has a weight of approximately 2 kilograms (kg) or more. In certain examples, the audio device has a weight of approximately 2.5 kg or more.

In some cases, the at least one hidden connection point includes at least two hidden connection points.

In certain aspects, the at least two hidden connection points includes four hidden connection points.

Two or more features described in this disclosure, including those described in this summary section, may be combined to form implementations not specifically described herein.

The details of one or more implementations are set forth in the accompanying drawings and the description below. Other features, objects and benefits will be apparent from the description and drawings, and from the claims.

### BRIEF DESCRIPTION OF THE DRAWINGS

FIG. 1 shows a perspective view of an audio device according to various implementations.

FIG. 2 shows a rear view of the audio device of FIG. 1.

FIG. 3 shows a cross-section of a portion of an audio device according to various implementations.

FIG. 4 shows another cross-section of a portion of an audio device according to various implementations.

FIG. 5 is a perspective view of an audio device and a mounting bracket according to various implementations.

FIG. 6 is a distinct perspective view of the audio device and the mounting bracket according to various implementations.

FIG. 7 is a side view of the audio device and mounting bracket shown in FIG. 6.

It is noted that the drawings of the various implementations are not necessarily to scale. The drawings are intended to depict only typical aspects of the disclosure, and therefore should not be considered as limiting the scope of the implementations. In the drawings, like numbering represents like elements between the drawings.

### DETAILED DESCRIPTION

This disclosure provides, at least in part, an audio device that beneficially incorporates a hidden connection point to enable coupling, e.g., with a fastener, through the device enclosure. This disclosure is also based, at least in part, on the realization that the hidden connection point enables effective retention of the audio device, e.g., for display and/or use, without visibly indicating such a connection point from the outer enclosure. The audio devices disclosed according to various implementations can be configured for use as conventional end-user (or, consumer) devices, as display devices such as in a retail or showroom environment, or in a fixed installation environment such as in a public space or hotel room. Due to the hidden nature of the connection point and its isolation from the acoustic cavity, an audio device according to various implementations can be manufactured without concern for specific end usage. Further, the audio device used as a display unit can be configured to operate, e.g., during display or subsequently, without impacting acoustic performance or ingress protection (IP) standard. This contrasts with conventional audio devices that have specific display units, such as display units not configured to output audio, or those that are no longer usable after being installed as display units. Additionally, the audio devices disclosed according to various implementations can facilitate installation, e.g., via a mounting bracket that is sized to complement the device's outer enclosure. In such cases, the mounting bracket can include a corresponding mounting aperture that aligns with the hidden connection point to facilitate location of that hidden connection point.

Commonly labeled components in the FIGURES are considered to be substantially equivalent components for the purposes of illustration, and redundant discussion of those components is omitted for clarity.

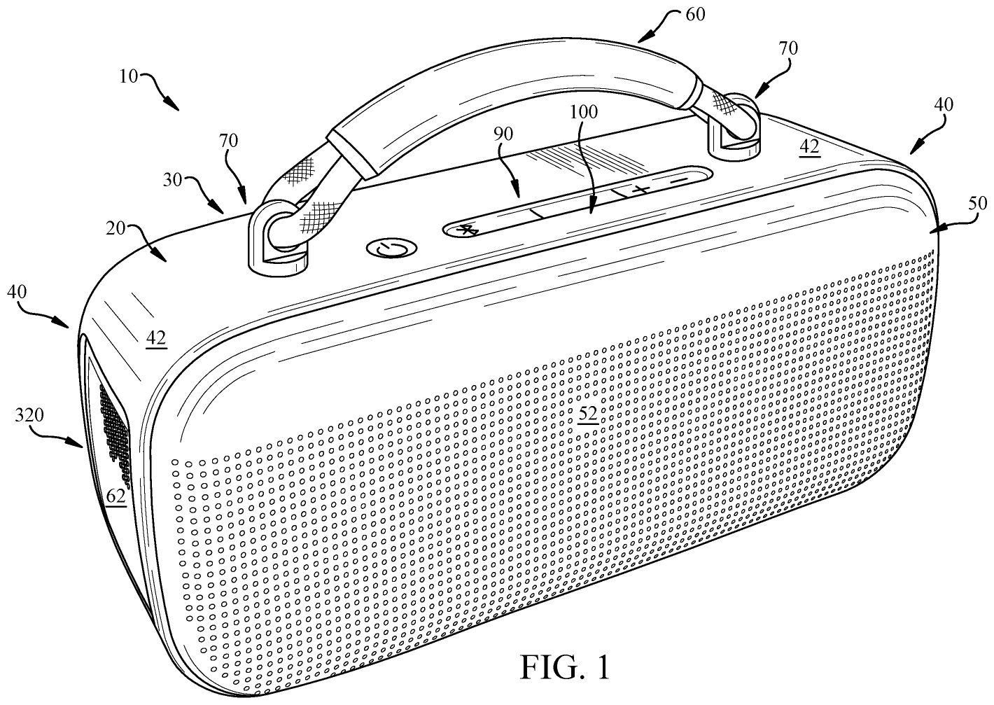

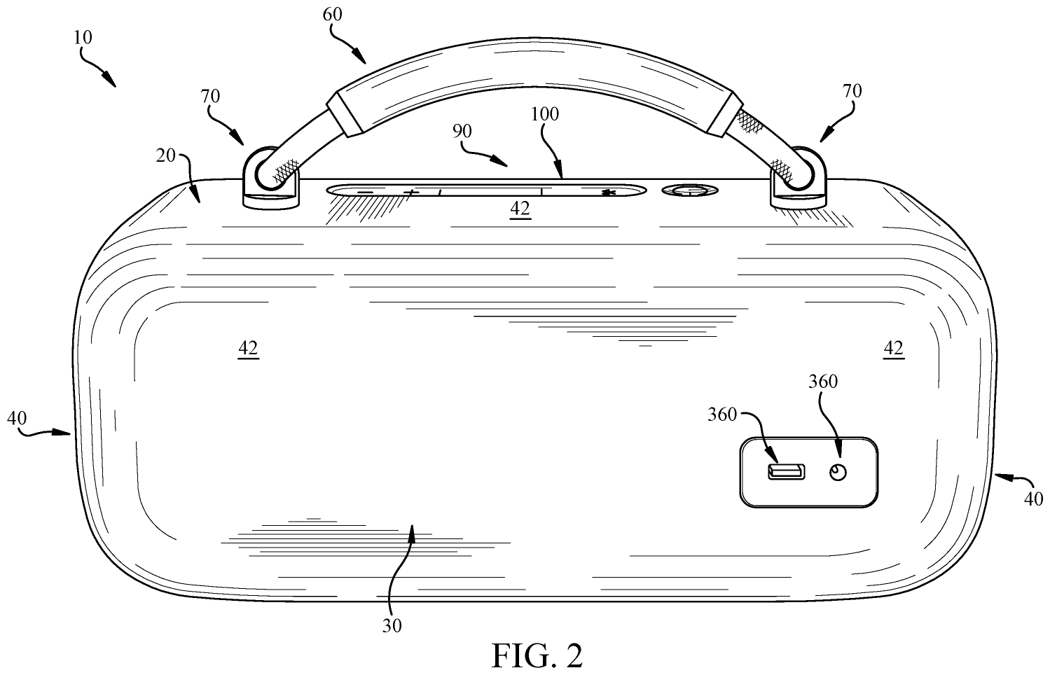

FIG. 1 shows a perspective view of an audio device 10 according to various implementations. FIG. 2 shows a rear view of the audio device 10. As shown, the audio device 10 can include an outer enclosure 20 that houses an acoustic cavity (not shown) and electronic components such as a transducer, controller (e.g., one or more control circuits such as found on printed circuit boards (PCBs), and communications equipment such as one or more wireless communication devices and associated chips/chipsets. The outer enclosure 20 is shown in this example implementation as having a back 30, sidewalls 40, and a front 50. In some cases, the front 50 includes a grille 52. However, it is understood that the grille 52 can be located in distinct positions in different implementations. In some cases, vents (or additional grilles 62) are shown along portions of sidewalls 40, e.g., on sides of the outer enclosure 20. In one example, the back 30 and sidewalls 40 are formed of a single (i.e., continuous) piece of material, e.g., a compliant material including silicone and/or rubber. However, the back 30 and sidewalls 40 can be formed of distinct material or distinct pieces of material in additional implementations. Additional examples of material types, sidewall and back configurations, and features of an outer enclosure for an audio device are described in U.S. Pat. No. 11,683,621 (“Ingress Resistant Portable Speaker,” issued on Jun. 20, 2023), the entire contents of which are incorporated by reference herein. In one example, the back 30 and sidewalls 40 include a cover (or an outer surface) 42 that is the outermost surface of the audio device 10. In the example audio device 10 shown in FIGS. 1 and 2, an accessory 60 is shown coupled with the outer enclosure 20 at one or more accessory mounts 70. The accessory mount(s) 70 (two shown) enable mounting of the accessory 60 such as a handle, strap, clip, etc. In the depicted example, the accessory 60 includes a handle. An interface 90, which can include one or more interface buttons 100, is illustrated along one of the sidewalls 40 in this example, e.g., along an upper surface.

Notably not shown in FIGS. 1 and 2 are hidden connection points that are configured to receive a corresponding fastener for connecting with an external device, e.g., a mount. That is, the connection points disclosed according to various implementations are hidden such that they not visible from the exterior (e.g., on cover 42) of the audio device 10.

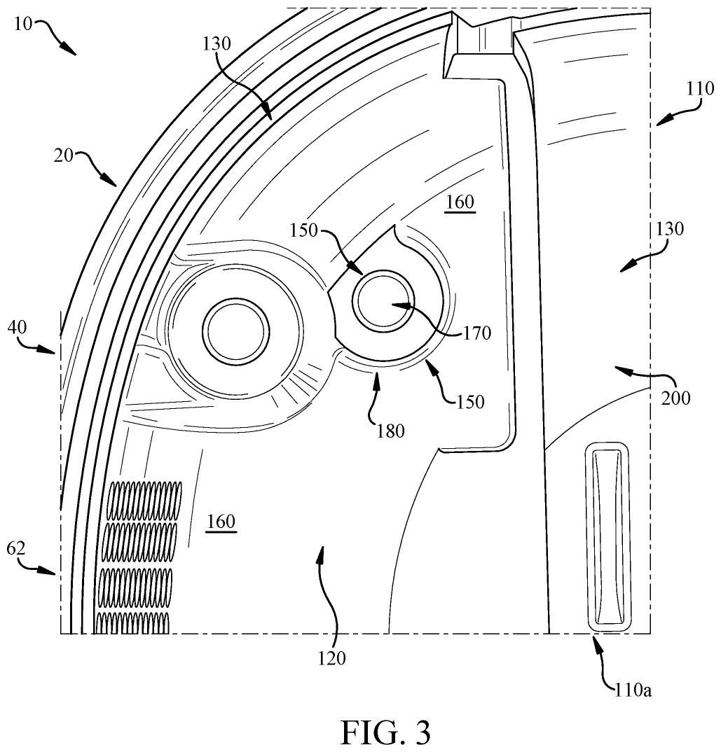

FIG. 3 shows an interior 110 of a portion of the audio device 10, e.g., near an edge of the back 30, including a cavity 120 contained within the outer enclosure 20. In this example, FIG. 3 shows a section of the audio device 10 with the front 50 (e.g., grille) removed. In certain cases, an inner enclosure 130 is positioned within the outer enclosure 20. In certain cases, the inner enclosure 130 includes a material that is harder (e.g., less compliant) than the outer enclosure 20, such as, a hard plastic or composite material. In some aspects, the outer enclosure 20 is over-molded on the inner enclosure 130. In any case, the audio device 10 includes at least one hidden connection point 150 that is configured to receive a corresponding fastener by penetrating the outer enclosure 20, e.g., penetrating the outer enclosure 20 through the back 30. In certain cases, the hidden connection point 150 is outlined on the inner enclosure 130, e.g., along an inner surface 160 thereof. In a particular example, the hidden connection point 150 includes a slot 170 for receiving a fastener. The slot 170 can be entirely enclosed by the outer enclosure 20. In a particular example, along the inner enclosure 130, the hidden connection point 150 is defined by a ridge 180 that can provide structural reinforcement of the connection between the fastener and the audio device 10. In some cases, the ridge 180 approximately (or in some cases, completely) surrounds the hidden connection point 150 to structurally reinforce the inner enclosure 130 and prevent cracking when a fastener is installed through the slot 170.

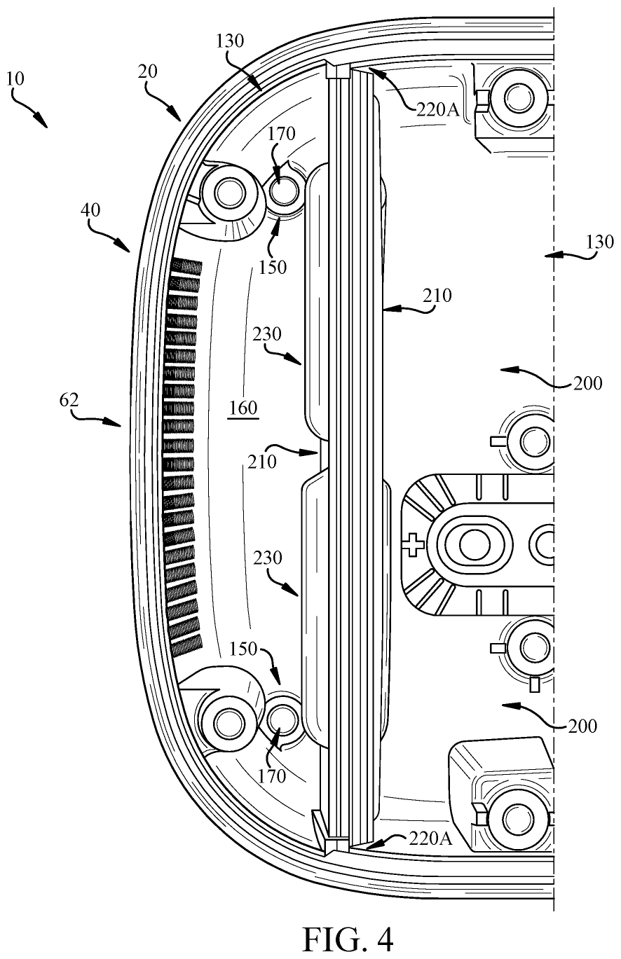

FIG. 4 illustrates another view of the interior of the audio device 10 with the front (e.g., grille) 50 removed. In this view, two distinct hidden connection points 150 are visible at the rear of the inner enclosure 130, and another two hidden connection points 150 (not shown) are present on an opposite side of the inner enclosure 130. However, the audio device 10 can include any number of hidden connection points suitable to aid in connecting with an external device. As is also shown in this view, an acoustic cavity 200 is located within the inner enclosure 130, and is separated from the hidden connection points 150. In a particular example, the acoustic cavity 200 is physically separated from the acoustic cavity 200 by a wall 210. In some cases, the wall 210 extends between distinct portions 220A, 220B of the inner enclosure 130. A similar wall can be positioned on an opposing side of the acoustic cavity 200 (not shown) such that the walls 210 defines an acoustically sealed volume. In certain examples, the wall 210 includes an acoustic element such as a passive radiator 230 (e.g., two shown). In other implementations, the wall 210 can include a fixed piece of material, and not necessarily include a passive radiator. In those cases, the acoustic cavity 200 can be ported, e.g., to aid in pressure regulation and/or tuning. A port (not shown) may be located along one or more walls that is acoustically coupled with the acoustic cavity.

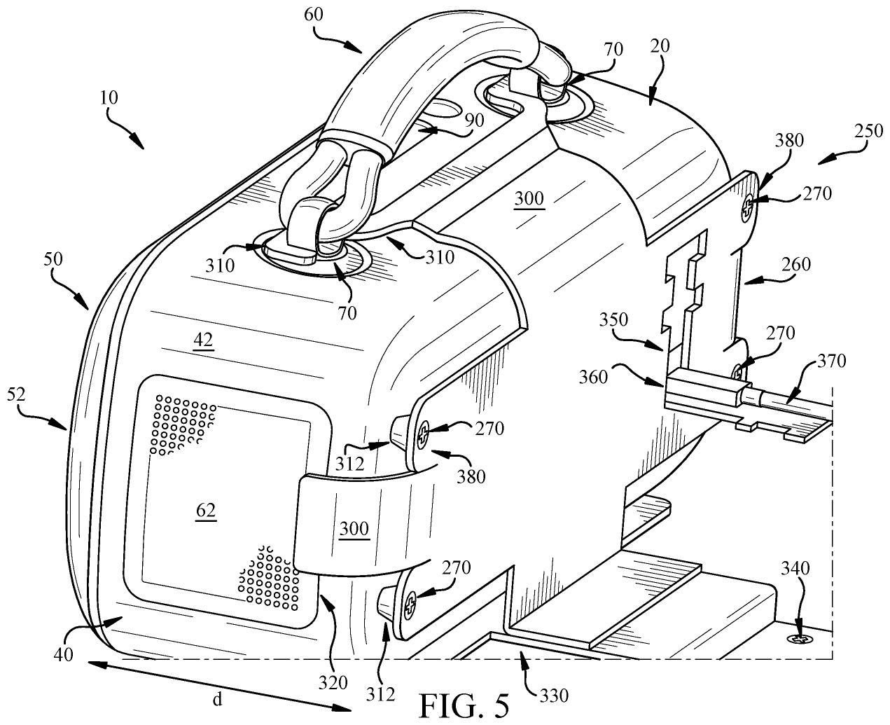

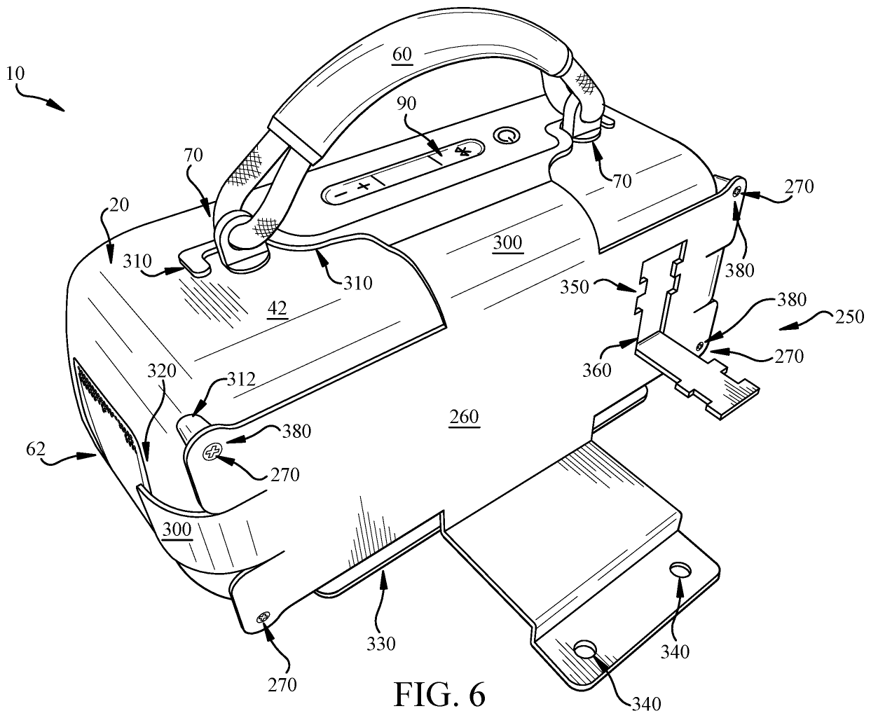

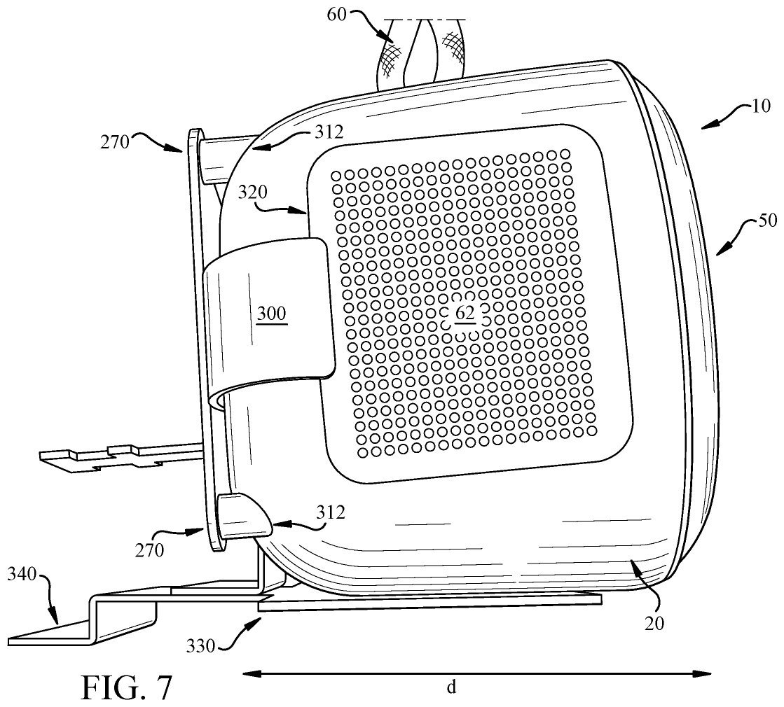

FIG. 5 shows a perspective view of the audio device 10 coupled with an external device 250. In this example, the external device 250 includes a mounting or display bracket (or simply, bracket 260). In certain cases, the bracket 260 is connected with the audio device 10 via fasteners 270 that extend through the hidden connection point(s) 150. In some examples, the fasteners 270 include screws. In a particular example, the screw includes a locking screw or a self-tapping screw. In certain cases, the hidden connection points 150 are pre-threaded. In other cases, the hidden connection points 150 are configured to receive a tool (e.g., driver head or drill bit) to define threads for coupling with a fastener 270 (e.g., a screw). FIG. 6 shows a distinct perspective view of the audio device 10 coupled with the external device 250, e.g., bracket 260. FIG. 7 shows a side perspective of the audio device 10 coupled with the bracket 260.

In the example depicted in FIGS. 3-7, the outer enclosure 20 is sized to complement the external device 250, e.g., the bracket 260. In certain cases, the bracket 260 aids in at least one of, display of the audio device 10, fixed use of the audio device 10, or theft deterrence for the audio device 10.

In one example, four distinct fasteners 270 are used to connect the bracket 260 with the audio device 10. For example, four hidden connection points 150 (FIGS. 3, 4) enable connecting the bracket 260 to the audio device 10 with fasteners 270. In various implementations, the hidden connection points 150 are each configured to receive a fastener 270 that extends through the outer enclosure 20. As described herein, in various implementation, each fastener 270 penetrates the outer enclosure 20 to engage each hidden connection point 150.

In a particular example, the external device 250 includes a set of arms 300. In some cases, the set of arms 300 extend only partially along the sidewalls 40 of the audio device 10 when mounted. In particular aspects, the fasteners 270 provide a significant portion of the retention force on the audio device 10 from the external device 250 (e.g., mounting bracket). For example, the arms 300 can be positioned to extend along only approximately 60 percent, approximately 50 percent, approximately 40 percent, or approximately 30 percent of the depth (d) of the audio device 10 (e.g., as measured from front to back or vice versa), such that the fasteners 270 provide a non-trivial portion of the retention force on the audio device 10 in the bracket 250. In certain cases, the fasteners 270 provide at least half of the retention force on the audio device 10 in the bracket 260. As noted herein, in certain non-limiting cases the audio device 10 has a significant weight relative to conventional portable speakers, e.g., approximately 2 kg or more. In various non-limiting implementations, the audio device 10 weighs approximately 2.2 kg or more. In such cases, the hidden connection points and corresponding fasteners 270 can be particularly beneficial in retaining the audio device 10 (e.g., with bracket 260) for display and/or use. That is, conventional mounting brackets used to retain an audio device 10 with this much weight may be required to have longer or more extensive arms to engage the audio device, which may negatively impact the display characteristics of the audio device 10, e.g., hiding more of the audio device from view. Further, such extensive or longer arms create additional contact points along the audio device that could contribute to acoustic artefacts such as ringing or vibration that are not desirable when demonstrating the audio device in use. In further implementations, the audio device 10 weights less than 2 kg, e.g., approximately 0.5 kg, 1.0 kg, or approximately 1.5 kg as non-limiting examples.

Further, as shown in FIGS. 5 and 6, in certain examples, one or more arms 300 include extensions 310 (or, additional arms) configured to engage (e.g., at least partially wrap around) an accessory mount 70 on the audio device 10. In such cases, a top (or upper) arm 300 includes an extension 310 for engaging an accessory mount 70 on the audio device 10. Further, additional arms 300 can include ridges or protrusions for engaging a ledge or recess 320 on the wall (e.g., sidewall 40) of the audio device 10. In certain cases, the ridges or protrusions on the additional arms 300 can snap or slide to engage the recess 320 on the wall, providing a tactile and/or audible indicator that the audio device 10 is seated within the arms 300. In certain cases, the bracket 260 includes a base 330 on which the audio device 10 can rest, and in certain implementations, the base 330 includes at least one anchoring aperture 340 for coupling the base 330 to a surface (e.g., a tabletop or wall). In particular implementations, the bracket 260 includes an access slot 350 that enables access to one or more connectors 360 on the audio device 10, e.g., an input/output connector such as a Universal Serial Bus (USB) type connector, an audio input/output connector, and/or a power source connector. An external connector 370, such as a USB connector is illustrated for example in FIG. 5.

In particular cases, one or more hidden connection point(s) 150 is configured to be located with a corresponding mounting aperture 380 in the bracket 260. In certain of these cases, when the audio device 10 is seated in the bracket 260, the mounting apertures 380 in the bracket 260 align with the hidden connection points 150 to enable a user to penetrate the outer enclosure 20 and deliver the fasteners 270 to the hidden connection points 150. In a particular case, the mounting apertures 380 in the bracket 260 are defined by a guide or alignment member 312 in the bracket 260. The mounting apertures 380 can align with the hidden connection points 150 when the audio device 10 is fully seated in the bracket 260.

In various implementations, an approach to mounting the audio device 10 to the bracket 260 can include: i) positioning the mounting bracket 260 on the audio device 10 (or positioning the audio device 10 in the mounting bracket 260); ii) positioning corresponding fastener(s) 270 in each of a set of mounting apertures 380; iii) puncturing the outer enclosure 20 with the corresponding fastener 270; and iv) seating the corresponding fastener 270 in each of the hidden connection points 150. In various implementations, the outer enclosure 20 can be first punctured with a tool such as a drill bit. In other cases, the fastener 270 can act to first puncture the outer enclosure 20. In certain implementations, seating the corresponding fastener 270 includes securing the bracket 260 to the audio device 10, e.g., by screwing or otherwise inserting the fastener 270 into the hidden connection point 150 (e.g., slot or opening) until engaged.

Returning to FIGS. 3 and 4, in various implementations, the wall 210 separates the hidden connection point(s) 150 from the acoustic cavity 200. In these cases, the fastener(s) 270 are also separated from acoustic cavity 200. That is, each fastener 270 seated in a hidden connection point 150 does not impact an acoustic performance of the audio device 10. In still further cases, the wall 210 provides additional ingress protection (IP) for the acoustic cavity 200 such that the audio device 10 maintains an IP rating even when fasteners 270 are seated in the hidden connection points 150 (as defined by International Protection Marking standards set forth by the International Electrotechnical Commission (IEC)). For example, the fastener(s) 270 do not impact an IP rating of the audio device 10, such that the audio device 10 maintains an IP rating of at least IP67 in various implementations.

In various implementations, the audio device 10 including one or more hidden connection points 150 appears substantially identical (e.g., without more than nominal visible distinction) to a reference audio device that does not have hidden connection points 150. For example, a reference audio device being of the same type as the audio device 10 may or may not have hidden connection points 150, and may not be configured for mounting and/or display in the same manner as audio device 10. In these cases, from looking at the outer enclosure 20, it is not possible to detect a distinction between the audio device 10 and that reference audio device, i.e., the outer enclosures of those devices are substantially identical.

As noted herein, the audio devices 10 disclosed according to various implementations provide numerous benefits relative to conventional audio devices. For example, relative to conventional audio devices, the audio devices disclosed herein including a hidden connection point enable effective retention of the audio device, e.g., for display and/or use without visibly indicating such a connection point from the outer enclosure. The audio devices disclosed according to various implementations can be configured for use as conventional end-user devices, as display devices such as in a retail or showroom environment, or in a fixed installation environment such as in a public space or hotel room. Due to the hidden nature of the connection point and its isolation from the acoustic cavity, an audio device according to various implementations can be manufactured without concern for specific end usage. Further, the audio device used as a display unit can be configured to operate, e.g., during display or subsequently, without impacting acoustic performance or ingress protection (IP) standard. This contrasts with conventional audio devices that have specific display units, such as display units not configured to output audio, or those that are no longer usable after being fastened as display units. Additionally, the audio devices disclosed according to various implementations can facilitate installation, e.g., via a mounting bracket that is sized to complement the device's outer enclosure.

It is understood that the relative proportions, sizes and shapes of the audio device 10 and components and features thereof as shown in the FIGURES included herein can be merely illustrative of such physical attributes of these components. That is, these proportions, shapes and sizes can be modified according to various implementations to fit a variety of products. For example, while a substantially block (or rectangular cross-sectional) shaped loudspeaker may be shown according to particular implementations, it is understood that the loudspeaker could also take on other three-dimensional shapes in order to provide acoustic functions described herein.

The term “approximately” as used with respect to values herein can allot for a nominal variation from absolute values, e.g., of several percent or less. Where the term “comprising” is used in the present description and claims, it does not exclude other elements or operations. The term “based on” (as in “A is based on B”) is used to indicate any of its ordinary meanings, including the cases (i) “based on at least” (e.g., “A is based on at least B”) and, if appropriate in the particular context, (ii) “equal to” (e.g., “A is equal to B”). Similarly, the term “in response to” is used to indicate any of its ordinary meanings, including “in response to at least.”

In various implementations, components described as being “coupled” to one another can be joined along one or more interfaces. In some implementations, these interfaces can include junctions between distinct components, and in other cases, these interfaces can include a solidly and/or integrally formed interconnection. That is, in some cases, components that are “coupled” to one another can be simultaneously formed to define a single continuous member. However, in other implementations, these coupled components can be formed as separate members and be subsequently joined through known processes (e.g., soldering, fastening, ultrasonic welding, bonding). In various implementations, electronic components described as being “coupled” can be linked via conventional hard-wired and/or wireless means such that these electronic components can communicate data with one another. Additionally, sub-components within a given component can be considered to be linked via conventional pathways, which may not necessarily be illustrated.

A number of implementations have been described. Nevertheless, it will be understood that additional modifications may be made without departing from the scope of the inventive concepts described herein, and, accordingly, other implementations are within the scope of the following claims.

We claim:

1. An audio device comprising:
an outer enclosure,
an acoustic cavity within the outer enclosure, and
at least one hidden connection point in the outer enclosure, the at least one hidden connection point configured to receive a corresponding fastener by penetrating the outer enclosure.

2. The audio device of claim 1, wherein the outer enclosure includes a cover visible from an exterior of the audio device, and wherein the at least one hidden connection point is not visible from the exterior of the audio device.

3. The audio device of claim 1, wherein the at least one hidden connection point includes a slot for receiving the fastener and is entirely enclosed by the outer enclosure.

4. The audio device of claim 1, wherein the at least one hidden connection point enables connection with an external device using the fastener.

5. The audio device of claim 1, wherein the external device comprises a mounting bracket.

6. The audio device for claim 5, wherein the outer enclosure is sized to complement the mounting bracket.

7. The audio device of claim 5, wherein the mounting bracket includes a set of arms, wherein the set of arms extend only partially along sidewalls of the audio device when mounted.

8. The audio device of claim 5, wherein the at least one hidden connection point is configured to be located with a corresponding mounting aperture in the mounting bracket.

9. The audio device of claim 5, wherein the mounting bracket aids in at least one of,
display of the audio device, fixed use of the audio device, or theft deterrence for the audio device.

10. The audio device of claim 1, wherein the fastener includes a screw.

11. The audio device of claim 10, wherein the screw includes at least one of a locking screw or a self-tapping screw.

12. The audio device of claim 1, wherein the outer enclosure appears substantially identical to an outer enclosure of a reference audio device, wherein the reference audio device is of a same type as the audio device and does not include hidden connection points.

13. The audio device of claim 1, further comprising a wall within the outer enclosure, the wall separating the at least one hidden connection point from the acoustic cavity.

14. The audio device of claim 13, wherein the wall comprises a passive radiator.

15. The audio device of claim 13, wherein the fastener does not impact an acoustic performance of the audio device.

16. The audio device of claim 13, wherein the fastener does not impact an ingress protection (IP) rating of the audio device.

17. The audio device of claim 1, wherein the audio device has a weight of approximately 2 kilograms (kg) or more.

18. The audio device of claim 1, wherein the at least one hidden connection point includes at least two hidden connection points.

19. The audio device of claim 1, wherein the at least two hidden connection points includes four hidden connection points.

20. A method of mounting the audio device of claim 1 to a mounting bracket, the method comprising:
positioning the mounting bracket on the audio device, the mounting bracket having a set of mounting apertures,
positioning the corresponding fastener in each of the set of mounting apertures, puncturing the outer enclosure with the corresponding fastener, and
seating the corresponding fastener in each of the at least one hidden connection points.
